(19) United States
(12) Patent Application Publication
(10) Pub. No.: US 2010/0016394 A1
(43) Pub. Date: Jan. 21, 2010

(54) BIOCIDAL COMPOSITIONS

(76) Inventor: Michael V. Enzien, Lisle, IL (US)

Correspondence Address: The Dow Chemical Company, Intellectual Property Section, P.O. Box 1967, Midland, MI, 48641-1967, US

(21) Appl. No.: 12/503,441

(22) Filed: Jul. 15, 2009

Related U.S. Application Data
(60) Provisional application No. 61/081,948, filed on Jul. 18, 2008.

(51) Int. Cl. A01N 43/52; A01P 1/00; A01P 3/00; B32B 29/00

(52) U.S. Cl. 514/394; 428/537.7

(57) ABSTRACT

Provided are synergistic biocidal compositions. The compositions comprise diiodomethyltolylsulfone and methyl 2-benzimidazolecarbamate and optionally 1,3-dicyano-tetrachlorobenzene. The compositions are useful for controlling growth of microorganisms in a variety of applications, including in building materials such as wallboard panels.

### CROSS-REFERENCE TO RELATED APPLICATIONS

This application claims benefit of priority from U.S. Provisional Patent Application No. 61/081,948 filed Jul. 18, 2008, which provisional application is hereby incorporated by reference in its entirety.

### FIELD OF THE INVENTION

The invention relates to synergistic biocidal compositions of diiodomethyl-tolylsulfone and methyl 2-benzimidazolecarbamate and optionally 1,3-dicyano-tetrachlorobenzene, and to the compositions' use in the control of microorganism growth in various applications, such as building materials.

### BACKGROUND OF THE INVENTION

Microorganism contamination and growth can have serious consequences, such as degradation, breakdown, or spoilage of products and interference with a wide range of important industrial processes. In the building materials industry, for instance, growth of fungal microorganisms is a concern because of its potential effect on human health, and because of the costs associated with remediation or replacement. Fungal spores, released from surface growth, are well-recognized as allergens, and additional concerns have been raised regarding the toxicity of byproducts from the fungal spores.

Paper and paperboard used in building materials have been observed as sites for such fungal growth. Typically, moisture in paper, paperboard, and building materials is sufficient to maintain fungal growth and the cellulose of the paper and paperboard, along with the residual contaminants within the fiber web, offer a food source that is enhanced by other building product components such as starch binders. Other applications that are susceptible to microorganism growth and spoilage include paints and coatings, synthetic coverings such as plastic films, fiberglass sheets, adhesives, paper and packaging products, roofing and flooring felts, caulks, tape-joint compounds and building plasters.

A continuing need exists for biocidal compositions that effectively control the growth of microorganisms in products and industrial processes.

### BRIEF SUMMARY OF THE INVENTION

In one aspect, the invention provides a synergistic biocidal composition. Because of the synergy between the composition's constituents, lower amounts of the constituents may be used to achieve acceptable biocidal activity. The biocidal composition comprises: diiodomethyltolylsulfone and methyl 2-benzimidazolecarbamate and optionally 1,3-dicyano-tetrachlorobenzene.

In another aspect, the invention provides a wallboard. The wallboard comprises: a gypsum core having a first face and a second face; and facing paper substantially covering the first face, the second face, or both the first face and the second face of the gypsum core, wherein the facing paper comprises a biocidal composition as described herein.

In a further aspect, the invention provides facing paper for use in building materials such as wallboard panels. The facing paper comprises a biocidal composition as described herein.

In a still further aspect, the invention provides a method for inhibiting the growth of mold in building materials that contain facing paper. The method comprising including in or on the paper a biocidal composition as described herein.

### DETAILED DESCRIPTION OF THE INVENTION

As noted above, one aspect of the invention is the provision of a biocidal composition. The composition comprises diiodomethyltolylsulfone (DIMTS) and methyl 2-benzimidazolecarbamate (also known as carbendazim or BCM). DIMTS and BCM are common industrial biocides that are available separately from various commercial sources. Previously unknown, however, is that the combination of these biocides is synergistic. That is, the combined materials result in improved biocidal properties than would otherwise be expected based on their individual performance at the particular use-concentration. The observed synergy permits reduced amounts of the materials to be used to achieve acceptable biocidal properties.

Preferably, the weight ratio of DIMTS relative to BCM in the composition of the invention is at least about 1:1, preferably at least about 1.3:1, more preferably at least about 1.5:1, and even more preferably at least about 2:1. In some further preferred embodiments, the DIMTS:BCM weight ratio is at least about 2.5:1, at least about 4:1, or at least about 6:1. Also preferably, the weight ratio of DIMTS:BCM is no more than about 10:1, more preferably no more than about 9:1, and further preferably no more than about 8:1. In still further preferred embodiments, the weight ratio (DIMTS:BCM) is between about 3:1 and 1:1, or between about 2:1 and 1:1, or between about 1.5:1 and 1:1.

In a particularly preferred embodiment, the composition of the invention further comprises 1,3-dicyano-tetrachlorobenzene (also known as chlorothalonil or CTL). The inventor has discovered that the inclusion of CTL in the synergistic compositions of DIMTS and BCM described above further increases the synergy of the overall composition. Thus, by including CTL in the composition, further reduced amounts of the materials may be used to achieve acceptable biocidal properties.

The amounts of DIMTS and BCM relative to each other in the preferred DIMTS, BCM, and CTL composition are as described above. Thus, as between DIMTS and BCM, the weight ratio of DIMTS to BCM is preferably at least about 1:1, more preferably at least about 1.3:1, still more preferably at least about 1.5:1, and even more preferably at least about 2:1. In some further preferred embodiments, the DIMTS :BCM weight ratio is at least about 2.5:1, at least about 4:1, or at least about 6:1. Also preferably, the weight ratio of DIMTS:BCM is no more than about 10:1, more preferably no more than about 9:1, and further preferably no more than about 8:1. In still further preferred embodiments, the weight ratio (DIMTS:BCM) is between about 1.5:1 and 1:1.

As for the CTL in the DIMTS, BCM, CTL composition, it is preferred that the weight ratio of DIMTS relative to this component (CTL) is about 150:1 or less, more preferably 100:1 or less, even more preferably 80:1 or less, further preferably 60:1 or less, and still further preferably 40:1 or less. In further aspects, the weight ratio (DIMTS to CTL) is 30:1 or less, or 20:1 or less. It is also preferred that the weight ratio of DIMTS relative to CTL be at least about 5:1, more preferably at least about 10:1, and even more preferably at least about 15:1. In further aspects, the DIMTS to CTL weight ratio is preferably between about 100:1 and 5:1, more preferably between about 50:1 and 10:1, and even more preferably between about 45:1 and 15:1. In particularly preferred aspects, the weight ratio is between about 40:1 and 20:1.

According to further preferred embodiments, the compositions of the invention comprise DIMTS, BCM, and CTL at a weight ratio of about 20:10:1. In still further embodiments, the weight ratio is about 40:40:1.

DIMTS, BCM, and CTL are water insoluble compounds. Preferably, therefore, formulations of these compounds are prepared as aqueous dispersions, as nanoparticle, micro, or macro emulsions, or as solutions or ready to use concentrates in suitable other solvents. Additional components required to make stable dispersions, emulsions, ready to use concentrates and solutions of all the biocides may be used. Such components include, by way of example, cationic, anionic or nonionic surfactants, polymer and co-polymers; thickening agents; co-solvents; coupling agents; anti-foaming agent. Dispersions and nano-solutions may require particle size reduction of technical actives using one or more particle sizing reduction technologies, such as grinding, air or wet milling.

The biocidal compositions of the invention are effective in the control of microorganisms. For the purposes of this specification, the meaning of “microorganism” includes, but is not limited to, bacteria, fungi (including molds), algae, and yeast. Further, the words “control” and “controlling” should be broadly construed to include within their meaning, and without being limited thereto, inhibiting the growth or propagation of micro-organisms and killing microorganisms.

The compositions of the invention are useful at controlling microorganism growth in a variety of products and industrial processes. By way of example, one preferred use is in the building material industry, and in particular for controlling mold growth on wallboard and particularly preferably on gypsum based wallboard. Gypsum wallboard generally comprises a gypsum core and facing paper on one or both of its faces. The biocidal compositions are preferably incorporated in or on the facing paper and further optionally in the gypsum core.

For use with the facing paper, the biocide composition may be incorporated directly into the paper during its manufacture or the composition may be applied to one or both of the paper's surfaces. Thus, the composition may be added during any stage of the paper manufacturing process, including at the “wet-end” (e.g. thick stock, thin stock, machine chest, head box), or at the “dry-end” after the paper is formed such as by dipping, spraying, or other surface coating techniques (e.g. size press, calender stack, water box, spray bar, off-machine coater). The biocide composition can alternatively be applied to the surface of the paper during the manufacture of the wallboard as the paper is unrolled, after the paper facer is in contact with the gypsum slurry, after the gypsum slurry has set and sheets have been formed, and/or after the sheets have been further cut into standard sizes. Furthermore, the biocide composition may be applied onto the inner surface, the outer surface, or both of the front and/or back paper facings.

Preferably, the loading level of the biocide composition in the facing paper is such so as to provide a concentration of biocides (active ingredients) of up to about 3000 ppm, preferably up to about 1000 ppm, more preferably up to about 750 ppm. In further preferred embodiments, the actives concentration is preferably at least about 25 ppm, more preferably at least about 50 ppm, and even more preferably, at least about 75 ppm.

Additional biocides may be included in or on the facing paper, such as, but not limited to, zinc pyrithione, thiabendazole, o-phenylphenol (OPP) and its corresponding salts, bromonitrostyrene (BNS), 2-(thiocyanomethylthio) benzothiazole (TCMTB), sodium pyrithione, dodecylguanidine hydrochloride, bis-(dimethyldithiocarbamato)-zinc (ziram), bis(dimethylthiocarbamoyl)disulfide (thiram), or mixtures of two or more thereof. The facing paper may contain other optional components, such as additives that increase the moisture resistance of the facing paper including wax, silicones, or fluorochemicals, retention aids, flocculants, fixatives, sizing agents, binders, fillers, and thickeners.

The wall board facing paper is typically a multi-ply (e.g., 2 to 9 layers) cellulose based material manufactured from re-pulped newspapers or other recycled products such as corrugated cardboard or office paper. The basis weight of the paper is generally 36-60 lbs/1000 ft², preferably 40-50 lbs/1000 ft². For multi-layered facing paper, the biocide can be included in or on any layer. Preferably the biocide is included in or on the outer 1 to 3 layers of the multi-layered facing paper.

Although multi-layered paper is preferred, the invention is also applicable to single-ply cellulose based paper. In addition, the compositions can be used in other cellulose based building materials requiring mold resistance, such as facing paper for insulation, fiberglass-cellulose coverings, ceiling tile, backing for vinyl flooring, and air filters.

As noted above, the biocide compositions of the invention may optionally be incorporated in the gypsum core of a gypsum based wallboard, in addition to or instead of their inclusion in the facing paper. A major ingredient of gypsum wallboard core is calcium sulfate hemihydrate, commonly referred to as “calcined gypsum,” “stucco,” or “plaster of Paris.” Stucco has a number of desirable physical properties including its fire resistance, thermal and hydrometric dimensional stability, compressive strength, and neutral pH. Generally, wallboard is produced by enclosing a core of an aqueous slurry containing calcined gypsum and other materials between two large sheets of wallboard facing paper. After the gypsum slurry has set (i.e., reacted with the water present in the aqueous slurry) and dried, the formed sheet is cut into standard sizes. Methods for the production of gypsum wallboard generally are described, for example, in Kirk-Othmer Encyclopedia of Chemical Technology, Second Edition, 1970, Vol. 21, pages 621-24, the disclosure of which is incorporated herein by reference.

The gypsum core may contain various additional ingredients, including accelerators (such as potassium sulfate) for controlling the set time of the stucco, antidessicants (such as starch) to prevent the dehydration of calcium sulfate dihydrate crystals formed during setting of the core composition, additional lightweight aggregates (e.g., expanded perlite or vermiculite), and additives that increase the moisture resistance of the finished core (such as wax, silicones, or fluorochemicals).

Other biocides may be included in the core, either instead of or in addition to the biocidal compositions of the invention. Such biocides include, but are not limited to, one or more of sodium pyrithione, diiodomethyl-p-tolylsulfone (DIMTS), zinc pyrithione, thiabendazole, IPBC, n-alkyl isothiazolinones such as octylisothiazolinone (OIT), monohalo and dihalo substituted n-alkylisothiazolinones such chloromethylisothiazolinone (CMIT) and dichlorooctylisothiazolinone (DCOIT), methylene-bis-thiocyanate, dodecylguanidine hydrochloride, phenolics such as o-phenylphenol (OPP) and its corresponding salts, bromonitrostyrene (BNS), 2-(thiocyanomethylthio) benzothiazole (TCMTB), sodium pyrithione, carbendazim, chlorothalonil, bis-(dimethyldithiocarbamato)-zinc (ziram), bis(dimethylthiocarbamoyl)disulfide (thiram), or mixtures of two or more thereof.

In addition to their use in wallboard facing paper and core materials, the compositions of the invention are also useful for controlling microorganisms in a variety of other systems including, by way of example, in paints and coatings, synthetic coverings such as plastic films, fiberglass sheets, adhesives, paper and packaging products, roofing and flooring felts, caulks, tape-joint compounds and building plasters.

The following examples are illustrative of the invention but are not intended to limit its scope.

### EXAMPLES

### Example 1

### Paper Infusion Study

In this example unbleached Kraft paper (brown wrapping paper (density 0.0091 g/cm2) is infused with DIMTS, carbendazim (BCM) and chlorothalonil (CTL) over a broad concentration range. In addition, paired combinations as well as all 3 actives combined are also infused into Kraft paper samples. Infusion of fungicide into paper is conducted by first dissolving the technical actives in a volatile solvent followed by addition of 1 mL of a working stock solution onto the surface of the paper to give the appropriate concentration of active(s) in mg/kg paper. The solvent completely saturates the paper. In order to prevent solvent from leaching through paper onto container, the paper is supported with a Viton O-ring. The solvent saturated paper samples are allowed to dry in a chemical fume hood precipitating the fungicides within the paper. Chemical analyses of fungicide actives in the paper samples confirms that this infusion technique produces >90% incorporation efficiency based on target concentrations. Standard mold resistant tests are performed on duplicate sub samples from each paper infusion sample. A modified ASTM-G21 is the standard mold resistant test used for performance evaluation. Synergy indices are calculated for all combinations of actives using a mold resistant rating of 0 or 1 as the passing criteria for performance. Synergy calculations are made according to the following standard equation:

SI=(Cₐ/C_{A})+(C_{b}/C_{B}) 2 combination tests

SI=(Cₐ/C_{A})+(C_{b}/C_{B})+(C_{c}/C_{C}) 3 combination tests

where:

SI is the synergy index;

Cₐ is the lowest concentration of component A in combination with other active(s) required to pass test criteria;

C_{A} is the lowest concentration of component A alone required to pass test criteria;

C_{b} is the lowest concentration of component B in combination with other active(s) required to pass test criteria;

C_{B} is the lowest concentration of component B alone required to pass test criteria;

C_{c} is the lowest concentration of component C in combination with other active(s) required to pass test criteria; and

C_{C} is the lowest concentration of component C alone required to pass test criteria.

Table 1 shows the synergy results for the combination test of the actives, DIMTS, BCM and CTL. Any synergy index <1 is considered a synergistic combination. A synergy index of 1 indicates an additive effect and a synergy index greater than 1 indicates antagonism.

The results show highly synergistic blends of the 3 actives. DIMTS and BCM also show synergistic combinations.

TABLE 1
Synergy Calculation from Modified¹ G21 Mold Resistant Testing

| PPM (active) | | | Ratio | |
|---|---|---|---|---|
| DIMTS | BCM | CTL | DIMTS:BCM:CTL | Synergy Index |
| 4000 | | | | |
| | 1200 | | | |
| | | 1000* | | |
| 700 | 350 | 18 | 100/50/5 | 0.48 |
| 500 | 500 | 13 | 100/100/2.5 | 0.55 |
| 1000 | 500 | | 2/1 | 0.67 |
| 800 | 600 | | 4/3 | 0.70 |
| 800 | 800 | | 1/1 | 0.87 |
| 900 | 1200 | | 3/4 | 1.23 |
| 1000 | 1333 | | 1/1.3 | 1.36 |

¹Trichoderma virens was omitted from spore inocula.
*Highest concentration tested and still did not achieve ‘0’ or ‘1’. Endpoint is higher than this value

While the invention has been described above according to its preferred embodiments, it can be modified within the spirit and scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

What is claimed is:

1. A biocidal composition comprising: diiodomethyltolylsulfone and methyl 2-benzimidazolecarbamate.

2. The biocidal composition of claim 1 wherein the weight ratio of diiodomethyl-tolylsulfone to methyl 2-benzimidazolecarbamate is between about 10:1 and about 1:1.

3. The biocidal composition of claim 1 wherein the weight ratio of diiodomethyl-tolylsulfone to methyl 2-benzimidazolecarbamate is between about 3:1 and 1:1.

4. The biocidal composition of claim 1 further comprising 1,3-dicyano-tetrachlorobenzene.

5. The biocidal composition of claim 4 wherein the weight ratio of diiodomethyl-tolylsulfone to 1,3 -dicyano-tetrachlorobenzene is between about 150:1 and about 5:1.

6. The biocidal composition of claim 4 wherein the weight ratio of diiodomethyl-tolylsulfone to 1,3 -dicyano-tetrachlorobenzene is between about 45:1 and 15:1.

7. A wallboard comprising:
a gypsum core having a first face and a second face; and
facing paper substantially covering the first face, the second face, or both the first face and the second face of the gypsum core,
wherein the facing paper comprises a biocidal composition according to claim 1.

8. The wallboard of claim 7 wherein the biocidal composition is distributed through the facing paper.

9. The wallboard of claim 7 wherein the biocidal composition is in or on the facing paper in an amount to provide between about 25 ppm and 3000 ppm by weight of biocide actives based on the total weight of the facing paper.

10. The wallboard of claim 7 wherein the facing paper comprises an additional biocide selected from the group consisting of: zinc pyrithione, thiabendazole, phenolics or salts thereof, bromonitrostyrene (BNS), 2-(thiocyanomethylthio) benzothiazole (TCMTB), sodium pyrithione, dodecylguanadine hydrochloride, bis-(dimethyldithiocarbamato)-zinc (ziram), bis(dimethylthiocarbamoyl)disulfide (thiram), and mixtures of two or more thereof.

11. The wallboard of claim 7 wherein the facing paper is single ply cellulose based paper.

12. The wallboard of claim 7 wherein the facing paper is multi-layered cellulose based paper having between 2 and about 9 layers.

13. The wallboard of claim 12 wherein the biocidal composition is in or on the outer 1 to 3 layers of the multi-layered facing paper.

14. The wallboard composition of claim 7 wherein the gypsum core comprises the biocidal composition.

15. The wallboard of claim 7 wherein the gypsum core comprises a biocide selected from the group consisting of: diiodomethyl-p-tolylsulfone (DIMTS), zinc pyrithione, thiabendazole, IPBC, n-alkyl isothiazolinones such as octylisothiazolinone (OIT), monohalo and dihalo substituted n-alkylisothiazolinones such chloromethylisothiazolinone (CMIT) and dichlorooctylisothiazolinone (DCOIT), methylene-bis-thiocyanate, dodecylguanidine hydrochloride, phenolics such as o-phenylphenol (OPP) and its corresponding salts, bromonitrostyrene (BNS), 2-(thiocyanomethylthio) benzothiazole (TCMTB), sodium pyrithione, carbendazim, chlorothalonil, bis-(dimethyldithiocarbamato)-zinc (ziram), bis(dimethylthiocarbamoyl)disulfide (thiram), and mixtures of two or more thereof.

16. Facing paper for use with wallboard, the facing paper comprising a biocidal composition according to claim 1.

17. A method for inhibiting the growth of mold in building materials that contain facing paper, the method comprising including in or on the paper a biocidal composition according to claim 1.

18. A method of controlling microorganism growth in a system in need of such control, the method comprising incorporating in the system a biocidal composition according to claim 1, wherein the system is paints and coatings, synthetic coverings such as plastic films, fiberglass sheets, adhesives, paper and packaging products, roofing and flooring felts, caulks, tape-joint compounds and building plasters.
